(19) United States
(12) Patent Application Publication
(10) Pub. No.: US 2026/0295422 A1
(43) Pub. Date: Oct. 1, 2026

(54) GAME DATA PROCESSING METHOD, APPARATUS AND DEVICE, AND STORAGE MEDIUM

(71) Applicant: NETEASE (HANGZHOU) NETWORK CO., LTD., Hangzhou (CN)

(72) Inventor: Qi LIU, Hangzhou (CN)

(73) Assignee: NETEASE (HANGZHOU) NETWORK CO., LTD., Hangzhou (CN)

(21) Appl. No.: 19/479,262

(22) PCT Filed: Jul. 17, 2023
(86) PCT No.: PCT/CN2023/107689

§ 371 Date: Oct. 27, 2025

(30) Foreign Application Priority Data
Apr. 27, 2023 (CN) 202310485167.0

(51) Int. Cl. A63F 13/58; A63F 13/5372; A63F 13/56; A63F 13/822; A63F 13/87

(52) U.S. Cl. CPC A63F 13/58; A63F 13/5372; A63F 13/56; A63F 13/822; A63F 13/87; A63F 2300/308

(57) ABSTRACT

The present disclosure provides a method for processing game data, including: determining, in response to an attack operation initiated by a first virtual object in a discussion stage, a second virtual object corresponding to the attack operation, and determining a first to-be-eliminated virtual object from the first virtual object and the second virtual object based on the attack operation and a character attribute of the second virtual object.

### CROSS-REFERENCE TO RELATED APPLICATION

The present disclosure is a 371 national phase application of PCT Application No. PCT/CN2023/107689 filed Jul. 17, 2023, which claims priority to Chinese patent application No. 202310485167.0 filed with the China National Intellectual Property Administration on 27 Apr. 2023 and titled “METHOD FOR PROCESSING GAME DATA, APPARATUS FOR PROCESSING GAME DATA, DEVICE FOR PROCESSING GAME DATA, AND STORAGE MEDIUM”, the entire content of both of which are incorporated herein by reference for all purposes.

### TECHNICAL FIELD

The present disclosure relates to the technical field of games, and specifically relates to a method, system, and apparatus for processing game data.

### BACKGROUND

With the development of the Internet field, games can be seen everywhere in people's life, and have become one of many entertainment approaches in people's leisure time. Among many games, multiplayer online reasoning games are now popular games.

At present, most reasoning games, such as Werewolf® game, can be divided into two processes, namely an action process and a discussion process. In the action process, all players in a survival status can take actions. For example, a civilian player can do a task, and a werewolf can, for example., cause trouble, do a task, or kill a person. During discussion on home switching, a player can vote based on observations in the action process and speaking of other players in the discussion process, and identify the werewolve based on the voting result.

However, in the related art, the player can initiate a skill merely in a preset stage of the discussion process, thereby resulting in restricted operations of the player, and affecting the game experience of the player.

### SUMMARY

The present disclosure provides a method, system, and apparatus for processing game data to prevent restricted operations of players from affecting the game experience of the players in the related art.

According to a first aspect, the present disclosure provides a method for processing game data, including: providing a graphical user interface via a terminal, the graphical user interface comprising a virtual scenario of a current round stage, the current round stage comprising an action stage and a discussion stage, displaying, in the action stage, a first virtual scenario of the action stage on the graphical user interface, and controlling, in response to a moving operation for a first virtual object, the first virtual object to move in the first virtual scenario, controlling, in response to a preset trigger event, the graphical user interface to switch from the first virtual scenario to a second virtual scenario of the discussion stage, the second virtual scenario comprising an icon of the first virtual object and an icon of at least one further virtual object, the discussion stage comprising a speaking stage and a voting stage, the speaking stage comprising a plurality of speaking periods, each of the speaking periods corresponding to an equally long speaking duration, each virtual object speaking in a corresponding speaking period and entering the voting stage after the speaking stage ends, determining, in response to an attack operation initiated by the first virtual object in the discussion stage, a second virtual object corresponding to the attack operation, and determining a first to-be-eliminated virtual object from the first virtual object and the second virtual object based on the attack operation and a character attribute of the second virtual object.

According to a second aspect, the present disclosure provides a system including one or more memory collectively containing one or more programs, and one or more processors, where the one or more processors are configured to, individually or collectively, perform the steps of the method according to any one of the above embodiments in the first aspect.

According a third aspect, the present disclosure provides one or more non-transitory computer-readable storage media containing, in any combination, computer program code that, when executed by a computer system, perform the steps of the method according to any one of the above embodiments in the first aspect.

### DESCRIPTION OF THE DRAWINGS

To more clearly describe technical solutions of embodiments of the present disclosure, drawings to be used in the embodiments will be briefly introduced below, and it should be understood that the following drawings only show some embodiments of the present disclosure, and therefore should not be viewed as limiting the scope of the present disclosure. For those of ordinary skills in the art, other relevant drawings may also be obtained based on these drawings without creative work.

FIG. 1 is a schematic flowchart of a method for processing game data provided in an embodiment of the present disclosure;

FIG. 2 is a schematic interface diagram of a game interface provided in an embodiment of the present disclosure;

FIG. 3 is a schematic interface diagram of a game interface provided in another embodiment of the present disclosure;

FIG. 4 is a schematic interface diagram of a game interface provided in another embodiment of the present disclosure;

FIG. 5 is a schematic flowchart of a method for processing game data provided in another embodiment of the present disclosure;

FIG. 6 is a schematic interface diagram of a game interface provided in another embodiment of the present disclosure;

FIG. 7 is a schematic interface diagram of a game interface provided in another embodiment of the present disclosure;

FIG. 8 is a schematic flowchart of a method for processing game data provided in another embodiment of the present disclosure;

FIG. 9 is a schematic interface diagram of a game interface provided in another embodiment of the present disclosure;

FIG. 10 is a schematic interface diagram of a game interface provided in another embodiment of the present disclosure;

FIG. 11 is a schematic structural diagram of an apparatus for processing game data provided in an embodiment of the present disclosure; and

FIG. 12 is a schematic structural diagram of a device for processing game data provided in an embodiment of the present disclosure.

### DETAILED DESCRIPTION

In order to make objectives, technical solutions, and advantages of embodiments of the present disclosure clearer, the technical solutions in the embodiments of the present disclosure will be clearly and completely described below with reference to the drawings in the embodiments of the present disclosure. Apparently, the described embodiments are some, instead of all, of the embodiments of the present disclosure.

The components of the embodiments of the present disclosure, as generally described and illustrated in the accompanying drawings, can be arranged and designed in a variety of different configurations. Therefore, the following detailed description of the embodiments of the present disclosure provided in the drawings is not intended to limit the scope of the present disclosure, but merely represents selected embodiments of the present disclosure. All other embodiments obtained by those skilled in the art based on the embodiments of the present disclosure without creative work are encompassed within the scope of protection of the present disclosure.

In addition, flowchart used in the present disclosure show operations implemented according to some embodiments of the present disclosure. It should be understood that the operations of the flowcharts may be not implemented in sequence, and steps without logical contextual relationships may be implemented in a reversed sequence or concurrently. In addition, those skilled in the art may add one or more additional operations to the flowcharts, or remove one or more operations from the flowcharts, under the guidance of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

With the method for processing game data provided in the present disclosure, a player can initiate an attack operation in any stage in a discussion process, determine a second virtual object corresponding to the attack operation, and then determine a first to-be-eliminated virtual object from a first virtual object and the second virtual object based on the attack operation and a character attribute of the second virtual object. With such an arrangement, the player can initiate an attack operation in a speaking stage based on his own judgment, or listen to speaking of all players, and then initiate, after all players complete speaking, an attack operation in a voting stage. Through this approach, the player can flexibly initiate an attack operation in different stages based on the player's own needs, avoiding the problem that, previously, the player can initiate an attack operation merely in a preset stage and is restricted in operations. This improves the fluency of initiating an attack operation when a game is running on a terminal device.

Virtual scenario: It is a virtual scenario that is displayed (or provided) when an application program is running on a terminal or a server. In one embodiment, the virtual scenario is a simulation environment of real world, or is a partially simulated and partially fictional virtual environment, or is a purely fictional virtual environment. The virtual scenario is any one of a two-dimensional virtual scenario and a three-dimensional virtual scenario. The virtual environment may be, e.g., the sky, land, or ocean, where the land includes an environmental element, such as a desert or a city. The virtual scenario is a scenario with complete game logic of a virtual object such as user control.

Virtual object: It refers to a dynamic object controllable in the virtual scenario. In one embodiment, the dynamic object may be, e.g., a virtual character, a virtual animal, or an animated character. The virtual object is a character controlled by a player through an input device, or is Artificial Intelligence (AI) provided in a battle of a virtual environment by training, or is a Non-Player Character (NPC) provided in a battle of a virtual scenario. In one embodiment, the virtual object is a virtual character competing in the virtual scenario. In one embodiment, the number of virtual objects in the battle of the virtual scenario is preset, or is dynamically determined based on the number of clients joining the battle, which is not limited in the embodiments of the present disclosure. In a possible implementation, a user can control the virtual object to move in the virtual scenario, for example, control the virtual object to, e.g., run, jump, or crawl, and can also control the virtual object to battle with other virtual objects using a skill, a virtual prop, etc. provided by the application program.

Player character: It refers to a virtual object that can be controlled by a player to move in a game environment, and may also be called a shikigami character or a hero character in some electronic games. The player character may be at least one of different forms, such as a virtual character, a virtual animal, an animated character, and a virtual vehicle.

Game interface: It refers to an interface corresponding to an application program provided or displayed through a graphical user interface, and includes a UI interface for interaction between players and a game picture. In one embodiment, the UI interface may include a game widget (such as a skill widget, a movement widget, or a functional widget), an indicator identifier (such as a direction indicator identifier and a character indicator identifier), an information display region (such as a kill count and a game duration), or a game setting widget (such as system settings, stores, or gold coins). In one embodiment, the game picture is a display picture corresponding to a virtual scenario displayed on a terminal device, and the game picture may include a virtual object, such as a game character, a NPC character, and an AI character, that executes game logic in the virtual scenario.

Virtual item: it refers to a static object in the virtual scenario, such as terrain, a house, a bridge, and vegetation in the virtual scenario. The static object is often not directly controlled by the player, but can take a corresponding action in response to an interbehavior (such as an attack or demolition) of the virtual object in the scenario. For example, the virtual object can, e.g., demolish, pick up, drag, and construct a building. In one embodiment, the virtual item may also fail to respond to the interbehavior of the virtual object. For example, the virtual item may also be, e.g., a building, a door, a window, or a plant in the virtual scenario, but the virtual object cannot interact with it. For example, the virtual object cannot, e.g., destroy or demolish the window.

A scenario recording method in a game in one of the embodiments of the present disclosure may run on the terminal device or the server. The terminal device may be a local terminal device. When the scenario recording method in a game is running on the server, the scenario recording method in the game may be implemented and executed based on a cloud interaction system, where the cloud interaction system comprises a server and a client device.

In one embodiment, various cloud applications, such as a cloud game, may run under the cloud interaction system. Taking the cloud game as an example, the cloud game refers to a game method based on cloud computing. In an operating mode of the cloud game, an entity for operating a game program and an entity for presenting the game picture are separated. The storage and operation of the method for information processing are completed on a cloud game server. The client device functions to receive data, transmit data, and present the game picture. For example, the client device may be a display device with data transmission function in the vicinity of the user side, such as a mobile terminal, a television set, a computer, or a palm computer. However, the terminal device performing information processing is a cloud game server in cloud. When playing a game, the player operates the client device to transmit an operating instruction to the cloud game server. The cloud game server runs the game based on the operating instruction, encodes and compresses data such as the game picture, returns the data to the client device through a network, and finally decodes the data and outputs the game picture through the client device.

In one embodiment, the terminal device can be a local terminal device. Taking a game as an example, the local terminal device stores the game program and is configured to present the game picture. The local terminal device is configured to interact with the player through a graphical user interface, namely, the game program is downloaded, installed and operated through an electronic device conventionally. The local terminal device provides the graphical user interface for the player in various modes, for example, it can be rendered and displayed on a display screen of a terminal, or it is provided for the player through holographic projection. For example, the local terminal device may comprise a display screen and a processor. The display screen is configured to present the graphical user interface. The graphical user interface comprises the game picture. The processor is configured to run the game, generate the graphical user interface, and control display of the graphical user interface on the display screen.

The method provided in the present disclosure can be applied to, for example, a reasoning virtual scenario. In a reasoning game, a plurality of players involved in the game join in a same game round. After they enter the game round, different character attributes, such as identity attributes, are assigned to virtual objects of different players, and different character attributes are assigned to determine different camps, so that the players can perform tasks assigned by the game in different round stages of the game round to win the game. For example, a plurality of virtual objects with character attribute A “eliminate” virtual objects with character attribute B in a round stage to obtain victory in the game; or a virtual object with character attribute C performs a task corresponding to the character attribute. If the virtual object with the character attribute C in the round stage completes the corresponding task, the virtual object with the character attribute C achieves victory. Taking Werewolf Kill® as an example, 10 people usually need to be involved in a same game round. At the beginning of the game round, identity information (character attribute) of the virtual object in the game round is determined. For example, the identity information includes civilian identity and werewolf identity. A virtual object with the civilian identity wins the game by completing an assigned specified task in the round stage, or wins the game by eliminating a virtual object with the werewolf identity in a current game round. A virtual object with the werewolf identity performs an attack behavior on a further virtual object with non-werewolf identity in the round stage to eliminate the virtual object to win the game. It should be understood that the above embodiments are merely illustrations, there may be various character attributes in a specific game round, and each character attribute corresponds to a different winning manner, which can be specifically flexibly adjusted based on user needs, and is not limited to those given in the above embodiments.

Round stages of the reasoning game usually include two round stages: an action stage and a discussion stage.

In the action stage, one or more game tasks are usually assigned. In one embodiment, one or more corresponding game tasks are assigned to each virtual object, and the player controls a corresponding virtual object to move in the virtual scenario and perform a corresponding game task to complete the game round. In one embodiment, a common game task is determined for virtual objects with a same character attribute in the current game round; and in the action stage, the virtual objects involved in the current game round can move freely to different regions in the virtual scenario in the action stage to complete the assigned game task.

The virtual objects in the current game round include a virtual object with a first character attribute and a virtual object with a second character attribute. In one embodiment, when moving to a preset range of the virtual object with the first character attribute in the virtual scenario, the virtual object with the second character attribute can respond to an attack instruction and attack the virtual object with the first character attribute, to eliminate the virtual object with the first character attribute; or, the virtual objects in the current game round may further include a virtual object with a third character attribute, and the virtual object with the third character attribute need to win the game only after being eliminated by votes of other players; or, the virtual objects in the current game round may further include a virtual object with a fourth attribute, and the virtual object with the fourth attribute needs to win the game by finding and eliminating a target virtual object. It should be understood that the above embodiments are merely illustrations, and specific possible game attributes of the virtual objects in the current game round and how each game attribute achieves victory in the game can be adjusted based on specific game settings, and are not limited to those given in the above embodiments.

In the discussion stage, a virtual object representing a player is provided with a discussion function, with which a behavior of the virtual object in the action stage is displayed, to determine whether to eliminate a particular virtual object in the current game round.

Taking the Werewolf® as an example, a game round may include two stages: the action stage and the discussion stage. In the action stage, a plurality of virtual objects in the game round freely move in a first virtual scenario, and other virtual objects within a preset range can be seen on the game picture displayed from the perspective of the virtual objects. The virtual object with the civilian identity moves in the virtual scenario to complete the assigned game task. The virtual object with the werewolf identity destroys the task having been completed by the virtual object with the civilian identity in the virtual scenario, or can perform an assigned particular game task. Moreover, the virtual object with the werewolf identity can further attack the virtual object with the civilian identity in the action stage to eliminate the virtual object. When the game round stage enters from the action stage to the discussion stage, the player discusses a corresponding virtual object to try to determine the virtual object with the werewolf identity based on the game behavior in the action stage, determines the discussion result by voting, determines whether a virtual object needs to be eliminated based on the discussion result, eliminates, if a virtual object needs to be eliminated, the corresponding virtual object based on the discussion result, and otherwise, determines that no virtual object needs to be eliminated in a current discussion stage. In the discussion stage, the discussion may be conducted by, but not limited to, voice, text, or other approaches.

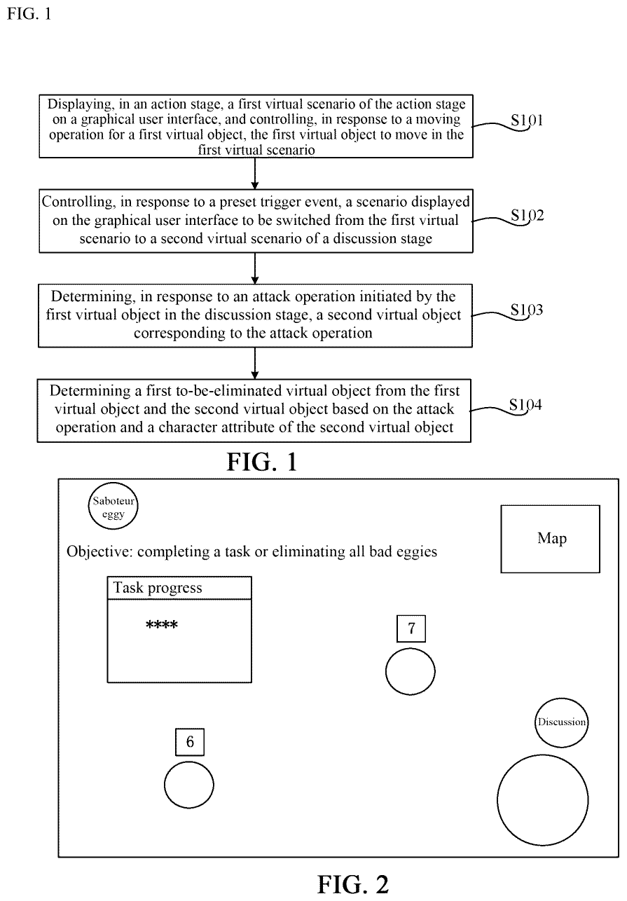

A method for processing game data provided in an embodiment of the present disclosure is described below in combination with a plurality of specific application examples. FIG. 1 is a schematic flowchart of a method for processing game data provided in an embodiment of the present disclosure, comprising: providing a graphical user interface via a terminal, the graphical user interface comprising a virtual scenario of a current round stage, the round stage comprising an action stage and a discussion stage. As shown in FIG. 1, the method comprises:
S101: displaying, in the action stage, a first virtual scenario of the action stage on the graphical user interface, and controlling, in response to a moving operation for a first virtual object, the first virtual object to move in the first virtual scenario.

During a game, a player can control, through a moving operation on the first virtual object, the first virtual object to move in the virtual scenario, such as controlling, through a sliding operation in the virtual scenario, the first virtual object to move based on the sliding operation, or controlling, by clicking a position of a direction operation/moving operation in the virtual scenario, the first virtual object to move, where, as the first virtual object moves, range of the virtual scenario displayed on the game interface will also change; and the player can perform a corresponding game task during the movement, or observe behaviors of the other virtual objects, etc.

In the action stage, players in different camps have different corresponding tasks. Players in each camp manipulate their own virtual objects to perform tasks in the first virtual scenario based on their own tasks. In one of embodiments of the present disclosure, the game may comprise a first camp, a second camp, and a third camp, where players in the first camp are required to perform a corresponding first task, and if the task is completed and there is still a surviving virtual object in the first camp, the first camp wins; players in the second camp can destroy the task having been performed by the players in the first camp, during the game, the players in the second camp may also perform the first task to disguise their own identity, but the first task performed by the players in the second camp is of no effect (even if the players in the second camp complete the first task, the progress of the first task having been performed by the players in the first camp will not be advanced), and if the number of uneliminated players in the second camp in the round stage is greater than a sum of the number of uneliminated players in the first and third camps, the second camp wins; and players in the third camp have their own corresponding second task, and may include a plurality of types of players, each type of players may have different corresponding third tasks, and if the players in the third camp are not eliminated in the round stage and successfully complete the corresponding second task, the players in the third camp win.
S102: controlling, in response to a preset trigger event, a scenario displayed on the graphical user interface to be switched from the first virtual scenario to a second virtual scenario of the discussion stage.

The second virtual scenario comprises an icon of the first virtual object and an icon of at least one further virtual object; the discussion stage comprises: a speaking stage and a voting stage, the speaking stage comprises a plurality of speaking periods, each of the speaking periods corresponds to an equally long speaking duration, and each virtual object speaks in a corresponding speaking period. In this embodiment, each virtual object speaks in its own speaking period in a preset sequence. After the speaking stage ends, the voting stage starts.

The number of speaking periods in the speaking stage is equal to the number of uneliminated virtual objects in the current game round. More specifically, each uneliminated virtual object has its own speaking period. In one of the embodiments of the present disclosure, each speaking period is 60 S. It should be understood that the above embodiment are merely illustrations, and specifically, the duration of each speaking period may be equal, or may be different. The duration of a speaking period may also be, e.g., 30 S, 45 S, or 90 S, specifically can be flexibly set and adjusted based on user needs, and is not limited to those given in the above embodiments.

In addition, the speaking sequence in the speaking stage is related to the identifier number of each virtual object in the round stage. Each virtual object speaks in sequence according to its corresponding identifier number. During speaking, remaining time of the current speaking period will also be displayed on the game interface (countdown will be performed in the speaking stage); an eliminated virtual object does not have a speaking period, and specifically, the eliminated virtual object cannot speak in the speaking stage.

However, in one embodiment of the present disclosure, an eliminated virtual object can listen to the speaking of an uneliminated virtual object in the speaking stage; or, an eliminated virtual object can speak to communicate with another eliminated virtual object in the speaking stage, and a dialogue between eliminated virtual objects is only limited to being heard among eliminated virtual objects, and will not be heard by uneliminated virtual objects.

FIG. 2 is a schematic interface diagram of a game interface provided in an embodiment of the present disclosure. As shown in FIG. 2, the game interface comprises a first game scenario. The first game scenario not only includes the first virtual object, but also may further include, e.g., other virtual objects. As shown in FIG. 2, a current first game scenario not only includes a first virtual object No. 7, but also includes a virtual object No. 6. In addition, the game interface further displays a scenario map corresponding to the current first game scenario, and a task objective, a task progress, a character attribute, a movement widget, a discussion widget, and the like of the first virtual object. As shown in FIG. 2, the current first virtual object is a player No. 7, whose character attribute is a saboteur eggy, and whose task objective is to complete a task or eliminate all bad eggies. If the first virtual object completes the task objective before the round stage ends, the first virtual object and virtual objects in a same camp with the first virtual object wins victory in the current round stage. It should be understood that the above embodiments are merely illustrations, and specific display contents, display modes, and display positions on the game interface can be flexibly adjusted based on user needs, and are not limited to those given in the above embodiments.

In the action stage, the player can trigger the game to enter the discussion stage by touching the discussion widget during action of each virtual object. In one embodiment of the present disclosure, each player can trigger the discussion widget a certain number of times, and all players can trigger the discussion widget a certain number of times. In addition, there is a cooling interval between two adjacent triggers. For example, there needs to be a 1-min interval between 2 discussion stages. Even if a current player still has a remaining number of times to trigger the discussion widget, but the time from last entry into the discussion stage is less than 1 min, in this case, the player still cannot trigger the discussion widget. The specific manner and triggering rules for triggering the discussion widget can be flexibly adjusted based on user needs, and are not limited to those given in the above embodiments.

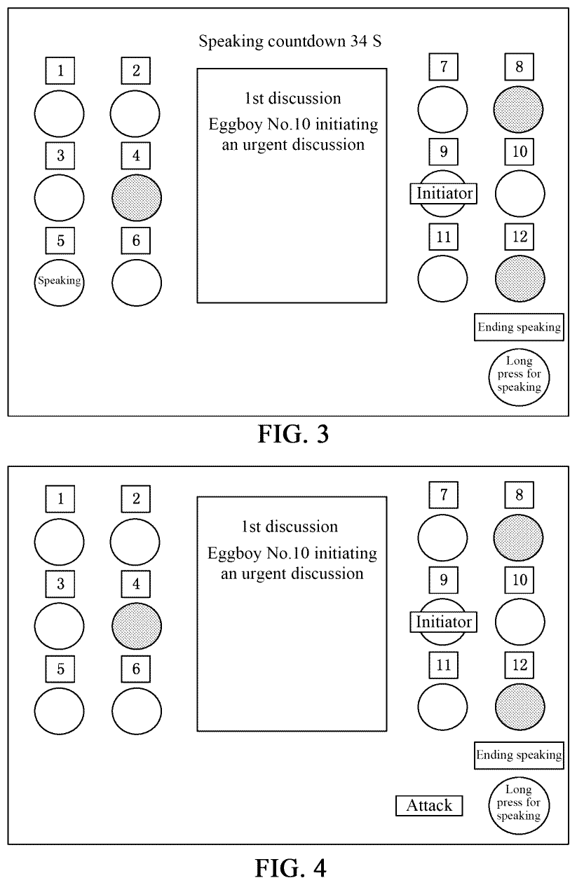

FIG. 3 is a schematic interface diagram of a game interface provided in another embodiment of the present disclosure. As shown in FIG. 3, for example, uneliminated virtual objects in the current round stage include: a virtual object No. 1, a virtual object No. 5, a virtual object No. 6, and a virtual object No. 9. Eliminated virtual objects, e.g., can be displayed in gray, and the uneliminated virtual objects, e.g., can be displayed normally; or, a preset elimination icon is displayed on an icon of each of the eliminated virtual objects, and an icon of each of the uneliminated virtual objects is displayed normally. It should be understood that the above embodiments are merely illustrations, and specific display modes between the eliminated virtual objects and the uneliminated virtual objects can be flexibly adjusted based on user needs, only need to be different to facilitate players to intuitively distinguish between them, and are not limited to those given in the above embodiments.

In one embodiment of the present disclosure, in the current speaking stage, an icon of each virtual object is displayed at a corresponding preset position. The icon of each virtual object, for example, may be, but is not limited to, an avatar identifier of a corresponding virtual object of each virtual object in the round stage, or a model style identifier corresponding to each virtual object in the round stage, or may be, but is not limited to, a user-defined avatar identifier, etc.; for example, may be, but not limited to, displayed on one side of the game interface, or uniformly displayed on both sides of the game interface, or may be displayed at the bottom of the game interface, etc. A corresponding serial number identifier is also displayed at a preset position around the icon of each virtual object. An icon of a virtual object that initiates a discussion may be marked with the wording “initiator”, or may be displayed in a preset display mode, for example, displaying a preset icon or in a preset color. In addition, the game interface further comprises a discussion interface, which displays the number of discussions in the current discussion stage in the round stage and the virtual object that initiates the discussion. For example, the discussion interface in FIG. 3 displays that the current discussion stage is a first discussion, and the initiator is a virtual object No. 10 (eggboy No. 10).

Further referring to FIG. 3, in the current speaking stage, a speaking sequence of each virtual object may be, for example, 1, 5, 6, and 9 (an initially speaking virtual object may also be determined based on a virtual object eliminated in a previous voting stage. For example, a player eliminated in the previous voting stage is a virtual object No. 8, then, for example, a next speaking stage starts from speaking by the virtual object No. 9, and the speaking sequence is 9, 1, 5, and 6; if a player eliminated in a previous round is a virtual player No. 3, a next speaking stage starts from speaking by a virtual player No. 5, and the speaking sequence is 5, 6, 9, and 1. It should be understood that the above embodiments are merely illustrations, and whether the specific speaking sequence is clockwise or counterclockwise and the manner of determining a first speaking virtual object can be flexibly adjusted based on user needs, and are not limited to those given in the above embodiments). As shown in FIG. 3, in the current game interface, the virtual object No. 5 is speaking, and only 34 seconds are remaining in its speaking period. Such a display mode can enable each player to intuitively see the remaining speaking time, thereby better grasping the speaking progress.
S103: determining, in response to an attack operation initiated by the first virtual object in the discussion stage, a second virtual object corresponding to the attack operation.

FIG. 4 is a schematic interface diagram of a game interface provided in another embodiment of the present disclosure. As shown in FIG. 4, the description is provided when the first virtual object is, for example, a to-be-assassinated virtual object. In this case, the game interface is a game interface corresponding to an assassination player, and an assassination widget is displayed on the game interface corresponding to the assassination player. If the assassination player clicks the assassination widget in the discussion stage, the attack operation (assassination operation) is triggered. In this case, the second virtual object corresponding to the attack operation can be determined based on the attack operation. In one of the embodiments of the present disclosure, the second virtual object may, for example, only be selected and determined from the uneliminated virtual objects, and specifically, the first virtual object fails to initiate an attack operation on an eliminated virtual object.

In one embodiment of the present disclosure, the attack operation can only be performed for any of the uneliminated virtual objects. In one of the embodiments of the present disclosure, for example, the first virtual object can only select one of the uneliminated virtual objects as the second virtual object. For example, in response to the attack operation initiated by the first virtual object in the discussion stage, whether the second virtual object corresponding to the attack operation is eliminated is determined; if the second virtual object is not eliminated, the second virtual object is determined to be the second virtual object corresponding to the attack operation; and if the second virtual object is eliminated, the attack operation is determined to be invalid. For example, the attack operation being invalid may mean that an attack effect is applied to the second virtual object, but the attack effect cannot generate a negative gain on an attribute of the second virtual object; or may mean that the attack operation cannot be released for the second virtual object. For example, when the attack operation acts on the second virtual object, the system does not respond.
S104: determining a first to-be-eliminated virtual object from the first virtual object and the second virtual object based on the attack operation and a character attribute of the second virtual object.

In one of the embodiments of the present disclosure, the first to-be-eliminated virtual object may be determined, for example, in a way as follows: if the character attribute of the second virtual object is consistent with a target character attribute in the attack operation, it means that the current first virtual object predicts the character attribute of the second virtual object correctly, and in this case the second virtual object is determined to be the first to-be-eliminated virtual object; while if the character attribute of the second virtual object is not consistent with the target character attribute in the attack operation, it means that the current first virtual object predicts the character attribute of the second virtual object incorrectly, and in this case the first virtual object is determined to be the first to-be-eliminated virtual object.

In one embodiment of the present disclosure, after the first to-be-eliminated virtual object is eliminated, elimination information will remain displayed on the game interface of the first to-be-eliminated virtual object, such as “You are sabotaged” or “saboteur failure, you are eliminated”. The specific display content can be flexibly adjusted based on user needs, is not limited to those given in the above embodiments, and is only required to prompt the user of being attacked or attack failure.

In order to increase the game experience of other players, only the first virtual object knows about the execution process of the attack operation. When the first to-be-eliminated virtual object is eliminated, the other players can only see that the first to-be-eliminated virtual object is eliminated, and the prompt message that “Eggboy No. 7 is eliminated” may be displayed synchronously on game pictures of the other players; or an elimination animation is displayed on an icon of the first to-be-eliminated virtual character synchronously on the game pictures of the other players, to indicate that the first virtual object is eliminated. The specific display effect on the game pictures of the other players can be flexibly adjusted based on user needs, and is only required to synchronously prompt that the first to-be-eliminated virtual character is eliminated.

However, the other players fail to know about the reason why the first to-be-eliminated virtual object is eliminated (in the round stage, more than one virtual object can initiate the attack operation in the attack stage), and the other players fail to know about whether the first to-be-eliminated virtual object is eliminated after being successfully attacked or after the attack fails. The other players can discuss and judge the identity of the first to-be-eliminated virtual character in a subsequent speaking stage based on action of the first to-be-eliminated virtual character in the action stage and its speaking in a previous speaking stage.

In one embodiment of the present disclosure, in order to enrich visual effects of the players, after the second virtual object is determined to be the first to-be-eliminated virtual object, a preset victory animation may be displayed on the icon of the first virtual object; or, after the first virtual object is determined to be the first to-be-eliminated virtual object, a preset failure animation is displayed on a model of the first virtual object; and accordingly, a corresponding animation may also be displayed on an icon of the second virtual object. The specific animation display mode, the display object, and display content can all be flexibly adjusted based on user needs, and are not limited to those given in the above embodiments.

In the present disclosure, since the speaking stage is prior to the voting stage, if the current discussion stage is in the speaking stage, after the first to-be-eliminated virtual object is determined, the first to-be-eliminated virtual object will also be controlled to be prohibited from speaking and/or voting; specifically, the speaking of the first to-be-eliminated virtual object will be ended/prohibited, the first to-be-eliminated virtual object fails to vote in the voting stage (the first to-be-eliminated virtual object is prohibited from voting), and the first to-be-eliminated virtual object has been eliminated. Since the other virtual objects can only vote for the uneliminated virtual objects, the first to-be-eliminated virtual object cannot receive votes from the other virtual objects in the voting stage.

In one embodiment of the present disclosure, if the character type of the first to-be-eliminated virtual object is a preset type, it is possible that even if it is eliminated, it may still speak at any time/or within preset time of the speaking stage, and specifically, the first to-be-eliminated virtual object will not be prohibited from speaking. However, no matter what character type of the first to-be-eliminated virtual object is, it will be prohibited from voting.

In one embodiment of the present disclosure, for example, if the first to-be-eliminated virtual object is eliminated in its own speaking period (during speaking), speaking of the first to-be-eliminated virtual object is immediately ended and a next virtual object speaks; while if the first to-be-eliminated virtual object is eliminated before its own speaking period, since character status of the first to-be-eliminated virtual object in this case has become eliminated, it does not have a qualification to speak, and specifically, the speaking period of the first to-be-eliminated virtual object will be directly skipped in the speaking stage.

In one of the embodiments of the present disclosure, a player can initiate an attack operation based on its own judgment in any stage of the discussion stage, or can initiate an attack operation in the speaking stage or in the voting stage, thereby avoiding the problem that the attack operation can only be initiated in the speaking stage, which may cause the player itself to be eliminated due to insufficient information obtained by the player and possible operation errors. The player can initiate an attack operation based on its own judgment after listening to speaking of all players in the game, thereby improving the game experience of the player.

With the method for processing game data provided in the present disclosure, the player can initiate an attack operation in any stage in the discussion process, determine the second virtual object corresponding to the attack operation, and then determine the first to-be-eliminated virtual object from the first virtual object and the second virtual object based on the attack operation and the character attribute of the second virtual object. With such an arrangement, the player can initiate an attack operation in the speaking stage based on his own judgment, or listen to the speaking of all players, and then initiate, after all players complete speaking, an attack operation in the voting stage, so that the player can flexibly initiate an attack operation in different stages based on his own needs, thereby avoiding the problem that previously, the player can initiate an attack operation merely in a preset stage and is restricted in operations; and improving the fluency of initiating an attack operation when a game is running on a terminal device.

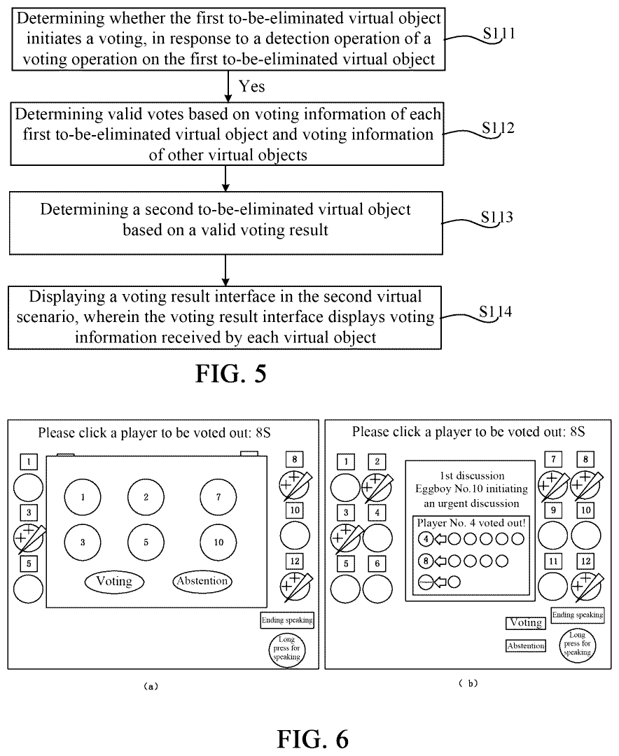

Based on the above embodiments, an embodiment of the present disclosure can further provide a method for processing game data, and an implementation process of the above method is illustrated below in conjunction with the drawings. FIG. 5 is a schematic flowchart of a method for processing game data provided in another embodiment of the present disclosure. As shown in FIG. 5, after the S104, the method may further include:
S111: determining whether the first to-be-eliminated virtual object initiates a voting, in response to a detection operation of a voting operation on the first to-be-eliminated virtual object.

If the first to-be-eliminated virtual object successfully triggers a voting operation before being eliminated, and specifically, the first to-be-eliminated virtual object performs a voting operation, selects a voted virtual object, and successfully submits a vote, the first to-be-eliminated virtual object is determined to initiate a voting.

If the first to-be-eliminated virtual object does not successfully trigger a voting operation before being eliminated, including but not limited to: the first to-be-eliminated virtual object does not trigger a voting operation; or the first to-be-eliminated virtual object triggers a voting operation but does not select a voted virtual object; or the first to-be-eliminated virtual object triggers a voting operation and selects a voted virtual object, but does not successfully submit a vote, the first to-be-eliminated virtual object is determined not to initiate a voting. The specific manner of determining whether a voting is initiated can be flexibly adjusted based on user needs, and is not limited to those given in the above embodiments.

If the first to-be-eliminated virtual object initiates a voting, S112 is executed.
S112: determining valid votes based on voting information of the first to-be-eliminated virtual object and voting information of other virtual objects.

The voting information of the first to-be-eliminated virtual object is counted towards the valid voting result. However, since the first to-be-eliminated virtual object has been eliminated, votes received by the first to-be-eliminated virtual object are not counted towards the valid voting result.

If the first to-be-eliminated virtual object does not initiate a voting, and specifically, if the first to-be-eliminated virtual object does not initiate a voting, the first to-be-eliminated virtual object is controlled to be prohibited from voting, and specifically, eliminated virtual objects fail to initiate a voting in the voting stage, and their voting widgets are all disabled.

FIG. 6 is a schematic interface diagram of a game interface provided in an embodiment of the present disclosure. As shown in FIG. 6(a), after entering the voting stage, the game interface of each player will display a voting interface. The voting interface displays icons/numbers of a plurality of uneliminated players in the current round stage. Each player needs to select a target voting object (i.e., an object expected to be voted out), and click its voting widget to complete voting. If the player fails to select a target voting object, it can choose to abstain from voting: clicking its abstention widget to trigger an abstention operation, for example, abstaining from this voting, and specifically, the player does not vote for any virtual object.

In one embodiment of the present disclosure, as shown in FIG. 6(b), after entering the voting stage, the game interface of each player displays a voting interface. The voting interface displays icons of all virtual characters in the current round stage, where an icon of each eliminated virtual object has a preset elimination identifier. Each player only can select a target voting object (an object expected to be voted out) from the icons of the plurality of uneliminated virtual objects in the voting interface, and then click its voting widget after selection to complete voting.

The voting stage also has a preset duration, and each player needs to complete voting within the preset duration. If a player still does not vote at the end of the voting countdown, or selects a target object but fails to submit a vote successfully, the player who does not complete voting is regarded as an abstaining player. Since each eliminated virtual object is prohibited from voting, the voting interface will not be displayed even if the game interface of the eliminated virtual object enters the voting stage. It should be understood that the above embodiments are merely illustrations, and the specific game interface form in the voting stage can be flexibly adjusted based on user needs, and is not limited to those given in the above embodiments.
S113: determining a second to-be-eliminated virtual object based on the valid voting result.

When the valid voting result is determined, a virtual object receiving a largest number of votes is the second to-be-eliminated virtual object. In one embodiment of the present disclosure, more than one virtual object may receive the largest number of votes, and this voting may be considered a dogfall, during which no virtual object will be eliminated due to the voting result, and a next action stage is entered; or more than one virtual object receiving the largest number of votes is eliminated, which specifically can be flexibly adjusted based on user needs, and is not limited to those given in the above embodiments.
S114: displaying a voting result interface in the second virtual scenario, where the voting result interface displays voting information received by each of the virtual objects.

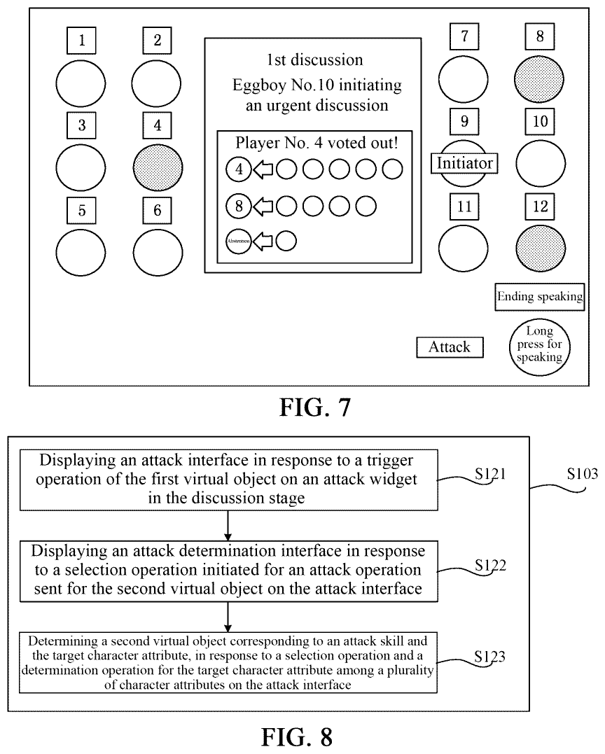

In one embodiment of the present disclosure, the displayed voting information may be determined, e.g., based on difficulty of the current round stage, for example, the difficulty of the current round stage is difficult. FIG. 7 is a schematic interface diagram of a game interface provided in another embodiment of the present disclosure. As shown in FIG. 7, the number of votes received by each virtual object can be displayed only in the voting result interface in a display mode of displaying a serial number identifier of each virtual object that receives votes in the voting result interface, and displaying a corresponding number of voting icons after the serial number identifier of each virtual object that receives votes, without displaying which virtual objects give the votes received by each virtual object respectively. In addition, some virtual objects may abstain from voting, and the number of abstentions of the abstaining players will also be displayed in the voting result interface. As shown in FIG. 7, the current voting result interface displays that a player No. 4 receives 5 votes, a player No. 8 receives 4 votes, and one player abstains from voting.

If the difficulty of the current round stage is simple, the number of votes received by each virtual object and which virtual objects give the votes received by each virtual object respectively can be displayed in the voting result interface. The expression manner in the game interface may be, for example, on the basis of FIG. 7, displaying a serial number identifier of a virtual object corresponding to a voting at a preset position of each voting icon (which virtual objects give the votes). It should be understood that the above embodiments are merely illustrations, and the specific display mode of the voting information in the voting result can be flexibly adjusted based on user needs, and is not limited to those given in the above embodiments.

If the first to-be-eliminated virtual object receives a vote, the vote is not counted towards the valid voting result, but will also be displayed in the voting result for reference by other virtual objects; and the first to-be-eliminated virtual object is prohibited from voting, but the first to-be-eliminated virtual object can see the voting result interface, like other uneliminated players.

Based on the above embodiments, an embodiment of the present disclosure can further provide a method for processing game data, and an implementation process of determining the second virtual object corresponding to the attack operation in the above method is illustrated below in conjunction with the drawings. FIG. 8 is a schematic flowchart of a method for processing game data provided in another embodiment of the present disclosure. As shown in FIG. 8, the S103 may include:
S121: displaying an attack interface in response to a trigger operation of the first virtual object on an attack widget in the discussion stage.

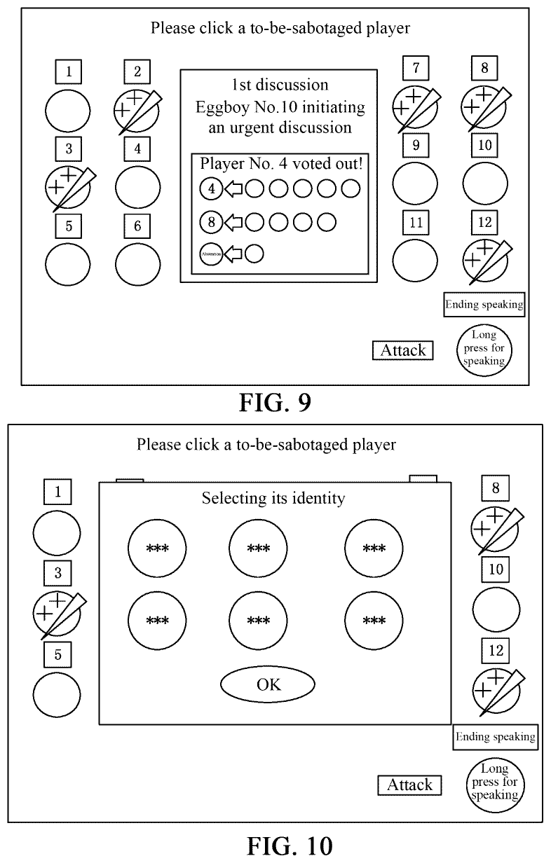

FIG. 9 is a schematic interface diagram of a game interface provided in another embodiment of the present disclosure. As shown in FIG. 9, the icon of each uneliminated virtual object on the attack interface is displayed in a preset display mode, and a prompt “click a to-be-sabotaged player” is also displayed on the top of the attack interface. The preset mode may be, for example, displaying the uneliminated virtual object in the attack interface with a preset animation (for example, swaying left and right at a preset frequency); or displaying the icon of the uneliminated virtual object normally, and displaying the icon of each eliminated virtual object in gray; or highlighting an outer border of the icon of the uneliminated virtual object, or displaying the icon of the eliminated virtual object with a preset elimination identifier. The specific preset display mode can be flexibly adjusted based on user needs, is only required to distinguish the eliminated virtual object from the uneliminated virtual object, and is not limited to those given in the above embodiments.
S122: displaying a determination interface in response to a selection operation initiated for the second virtual object on the attack interface.

The first virtual object can select the second virtual object from at least one selectable virtual object in the attack interface. The determination interface is displayed in response to the selection operation of the first virtual object. FIG. 10 is a schematic interface diagram of a game interface provided in another embodiment of the present disclosure. As shown in FIG. 10, the determination interface comprises a prompt “please select its identity”. In addition, the determination interface further displays a plurality of character attribute information. The first virtual object can view the plurality of character attribute information, and select a target character attribute of the second virtual object considered by itself from the plurality of character attribute information based on an action behavior of the second virtual object in the action stage and speaking information of the second virtual object in the speaking stage.

Further referring to FIG. 10, the determination interface further comprises a closure widget. If the first virtual object would like to change the selected second virtual object, it can trigger the closure widget. In response to the trigger operation of the closure widget, the first virtual object can close the determination interface to reselect the second virtual object in the attack interface.

Further referring to FIG. 10, the attack interface further comprises an attack cancellation widget. If the first virtual object would like to cancel the attack operation, the attack cancellation widget can be triggered to cancel the display of the attack interface.
S123: determining the second virtual object corresponding to the attack operation and the target character attribute, in response to a selection operation for the target character attribute among a plurality of character attributes on the determination interface.

With the method for processing game data provided in the present disclosure, the player can initiate an attack operation in any stage in the discussion process, determine the second virtual object corresponding to the attack operation and a target character attribute exclusive for the second virtual object, and then determine the first to-be-eliminated virtual object from the first virtual object and the second virtual object based on the target character attribute and the character attribute of the second virtual object. With such an arrangement, the player can initiate an attack operation in the speaking stage based on his own judgment, or can listen to the speaking of all players, and, after all players complete speaking, initiate an attack operation in the voting stage, so that the player can flexibly initiate an attack operation in different stages based on his own needs, thereby avoiding the problem that previously, the player can initiate an attack operation merely in a preset stage and is restricted in operations. Moreover, after determining the first to-be-eliminated virtual object, the method provided in the present disclosure will also display a corresponding animation on the icon of the first to-be-eliminated virtual object to enrich the visual effect of the player, further improve the user experience of the player; and improve the fluency of initiating an attack operation when a game is running on the terminal device.

An apparatus for processing game data provided in the present disclosure is described below in conjunction with the drawings. The apparatus for processing game data can implement the method for processing game data in any one of the above FIGS. 1-10. The above description is referred to for specific implementations and beneficial effects thereof, which will not be repeated below.

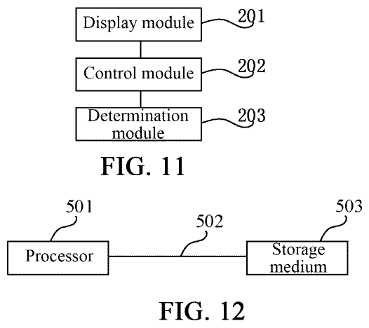

FIG. 11 is a schematic structural diagram of an apparatus for processing game data provided in an embodiment of the present disclosure. As shown in FIG. 11, the apparatus comprises: a display module 201, a control module 202, and a determination module 203.

The display module 201 is configured to display, in an action stage, a first virtual scenario of the action stage on a graphical user interface, and control, in response to a moving operation for a first virtual object, the first virtual object to move in the first virtual scenario.

The control module 202 is configured to control, in response to a preset trigger event, a scenario displayed on the graphical user interface to be switched from the first virtual scenario to a second virtual scenario of a discussion stage, the second virtual scenario comprising an icon of the first virtual object and an icon of at least one further virtual object; the discussion stage comprising a speaking stage and a voting stage, the speaking stage comprising a plurality of speaking periods, each virtual object speaking in a corresponding speaking period and entering the voting stage after the speaking stage ends.

The determination module 203 is configured to determine, in response to an attack operation initiated by the first virtual object in the discussion stage, a second virtual object corresponding to the attack operation, and determine a first to-be-eliminated virtual object from the first virtual object and the second virtual object based on the attack operation and a character attribute of the second virtual object.

In one embodiment, the determination module 203 is specifically configured to determine, in response to the character attribute of the second virtual object being consistent with a target character attribute in the attack operation, the second virtual object as the first to-be-eliminated virtual object; and determine, in response to the character attribute of the second virtual object not being consistent with the target character attribute in the attack operation, the first virtual object as the first to-be-eliminated virtual object.

In one embodiment, the control module 202 is specifically configured to control the first to-be-eliminated virtual object to be prohibited from speaking and/or voting.

The determination module 203 is specifically configured to determine whether the first to-be-eliminated virtual object initiates a voting, in response to a detection operation of a voting operation on the first to-be-eliminated virtual object; determine a valid voting result based on voting information of the first to-be-eliminated virtual object and voting information of other virtual objects, in response to the first to-be-eliminated virtual object initiating a voting, count the voting information of the first to-be-eliminated virtual object towards the valid voting result, not to count votes received by the first to-be-eliminated virtual object towards the valid voting result; and determine a second to-be-eliminated virtual object based on the valid voting result.

The display module 201 is specifically configured to display a voting result interface in the second virtual scenario, where the voting result interface displays voting information received by each of the virtual objects.

In one embodiment, the control module 202 is specifically configured to control, in response to the first to-be-eliminated virtual object not initiating a voting, the first to-be-eliminated virtual object to be prohibited from voting.

In one embodiment, the display module 201 is specifically configured to display an attack interface in response to a trigger operation of the first virtual object on an attack widget in the discussion stage; and display a determination interface in response to a selection operation initiated for the second virtual object on the attack interface.

The determination module 203 is specifically configured to determine the second virtual object corresponding to the attack operation and the target character attribute, in response to a selection operation for the target character attribute among a plurality of character attributes on the determination interface.

In one embodiment, an icon of an uneliminated virtual object on the attack interface is displayed in a preset display mode; and the determination module 203 is specifically configured to display the determination interface in response to a selection operation for the uneliminated virtual object on the attack interface.

In one embodiment, the display module 204 is specifically configured to cancel the display of the attack interface in response to a trigger operation for an attack cancellation widget.

In one embodiment, the determination module 203 is specifically configured to determine whether the second virtual object corresponding to the attack operation is eliminated in response to the attack operation initiated by the first virtual object in the discussion stage; determine that the second virtual object is the second virtual object corresponding to the attack operation in response to the second virtual object not being eliminated; and determine that the attack operation is invalid in response to the second virtual object being eliminated.

In one embodiment, the display module 201 is specifically configured to display a preset victory animation on the icon of the first virtual object.

In one embodiment, the display module 201 is specifically configured to display a preset failure animation on a model of the first virtual object.

The above apparatus is configured to implement the method provided in the above embodiments, and has similar implementation principles and technical effects, which will not be repeated here.

The above modules may be one or more integrated circuits configured to implement the above method, such as: one or more Application Specific Integrated Circuits (abbreviated as ASIC), or one or more microprocessors, or one or more Field Programmable Gate Arrays (abbreviated as FPGA). For another example, when one of the above modules is implemented in the form of a processing element scheduling program code, the processing element may be a general-purpose processor, such as a Central Processing Unit (abbreviated as CPU) or other processors capable of invoking a program code. For example, these modules may be integrated together and implemented in the form of a system-on-a-chip (SOC).

FIG. 12 is a schematic structural diagram of a device for processing game data provided in an embodiment of the present disclosure. The device for processing game data can be integrated into a terminal device or a chip of the terminal device.

As shown in FIG. 12, the device for processing game data comprises a processor 501, a bus 502, and a storage medium 503.

The processor 501 is configured to store a program, and the processor 501 invokes a program stored in the storage medium 503 to implement the method embodiments corresponding to the above FIGS. 1-10.

Specifically, steps of implementing the above method for processing game data by the processor 101 include: displaying, in an action stage, a first virtual scenario of the action stage on a graphical user interface, and controlling, in response to a moving operation for a first virtual object, the first virtual object to move in the first virtual scenario, controlling, in response to a preset trigger event, a scenario displayed on the graphical user interface to be switched from the first virtual scenario to a second virtual scenario of a discussion stage; the second virtual scenario comprising an icon of the first virtual object and an icon of at least one further virtual object; the discussion stage comprising: a speaking stage and a voting stage, the speaking stage comprising a plurality of speaking periods, each virtual object speaking in a corresponding speaking period and entering the voting stage after the speaking stage ends, determining, in response to an attack operation initiated by the first virtual object in the discussion stage, a second virtual object corresponding to the attack operation, and determining a first to-be-eliminated virtual object from the first virtual object and the second virtual object based on the attack operation and a character attribute of the second virtual object.

In some embodiments, the processor 101 implements a step of determining a first to-be-eliminated virtual object from the first virtual object and the second virtual object based on the attack operation and a character attribute of the second virtual object, which may include: determining, in response to the character attribute of the second virtual object being consistent with a target character attribute in the attack operation, the second virtual object as the first to-be-eliminated virtual object; and determining, in response to the character attribute of the second virtual object not being consistent with the target character attribute in the attack operation, the first virtual object as the first to-be-eliminated virtual object.

In some embodiments, after the processor 101 implements a step of determining, in response to the discussion stage being in the speaking stage, the first to-be-eliminated virtual object from the first virtual object and the second virtual object, the process may include: controlling the first to-be-eliminated virtual object to be forbidden from speaking and/or voting.

In some embodiments, in response to the discussion stage being in the voting stage, after the processor 101 implements the step of determining the first to-be-eliminated virtual object from the first virtual object and the second virtual object, the process may include: determining whether the first to-be-eliminated virtual object initiates a voting, in response to a detection operation of a voting operation on the first to-be-eliminated virtual object; determining a valid voting result based on voting information of the first to-be-eliminated virtual object and voting information of other virtual objects, in response to the first to-be-eliminated virtual object initiating a voting; counting the voting information of the first to-be-eliminated virtual object towards the valid voting result; not counting votes received by the first to-be-eliminated virtual object towards the valid voting result; determining a second to-be-eliminated virtual object based on the valid voting result; and displaying a voting result interface in the second virtual scenario, where the voting result interface displays voting information received by each of the virtual objects.

In some embodiments, after the processor 101 implements a step of determining whether the first to-be-eliminated virtual object initiates a voting, in response to a detection operation of a voting operation on the first to-be-eliminated virtual object, the process may include: controlling the first to-be-eliminated virtual object to be forbidden from voting, in response to determining that the first to-be-eliminated virtual object does not initiate a voting.

In some embodiments, the processor 101 implements a step of determining the second virtual object corresponding to the attack operation, in response to the attack operation sent from the first virtual object in the discussion stage, which may include: displaying an attack interface in response to a trigger operation of the first virtual object on an attack widget in the discussion stage; displaying a determination interface in response to a selection operation initiated for the second virtual object on the attack interface; and determining the second virtual object corresponding to the attack operation and the target character attribute, in response to a selection operation for the target character attribute among a plurality of character attributes on the determination interface.

In some embodiments, an icon of an uneliminated virtual object on the attack interface is displayed in a preset display mode; and the processor 101 implements a step of displaying the determination interface in response to an attack operation initiated for the second virtual object on the attack interface, which may include: displaying the determination interface in response to a selection operation on the uneliminated virtual object on the attack interface.

In some embodiments, the processor 101 may further implement a step of canceling the display of the attack interface in response to the trigger operation for the attack cancellation widget.

In some embodiments, the processor 101 implements the step of determining the second virtual object corresponding to the attack operation, in response to the attack operation sent from the first virtual object in the discussion stage, which may include: determining whether the second virtual object corresponding to the attack operation is eliminated, in response to the attack operation initiated by the first virtual object in the discussion stage; determining, in response to the second virtual object not being eliminated, the second virtual object as the second virtual object corresponding to the attack operation; and determining, in response to the second virtual object being eliminated, that the attack operation is invalid.

In some embodiments, after the processor 101 implements a step of determining that the second virtual object is the first to-be-eliminated virtual object, the process may include: displaying a preset victory animation on the icon of the first virtual object.

In some embodiments, after the processor 101 implements a step of determining that the first virtual object is the first to-be-eliminated virtual object, the process may include: displaying a preset failure animation on a model of the first virtual object.

With the method for processing game data implemented by the processor 101 in the above embodiments, the player can initiate an attack operation in any stage in the discussion process, determine the second virtual object corresponding to the attack operation and a target character attribute exclusive for the second virtual object, and then determine the first to-be-eliminated virtual object from the first virtual object and the second virtual object based on the target character attribute and the character attribute of the second virtual object. With such an arrangement, the player can initiate an attack operation in the speaking stage based on his own judgment, or can listen to speaking of all players, and, after all players complete speaking, initiate an attack operation in the voting stage, so that the player can flexibly initiate an attack operation in different stages based on his own needs, thereby avoiding the problem that previously, the player can initiate an attack operation merely in a preset stage, and is restricted in operations. Moreover, after determining the first to-be-eliminated virtual object, the method provided in the present disclosure will also display a corresponding animation on the icon of the first to-be-eliminated virtual object to enrich the visual effect of the player, further improve the user experience of the player; and improve the fluency of initiating an attack operation when a game is running on the terminal device.

In one embodiment, the present disclosure further provides a program product, such as a storage medium, storing a computer program, including a program, where the program, when run by a processor, implements an embodiment corresponding to the above method.

Specifically, steps of implementing the above skill release method by the processor include: displaying, in an action stage, a first virtual scenario of the action stage on a graphical user interface, and controlling, in response to a moving operation for a first virtual object, the first virtual object to move in the first virtual scenario; controlling, in response to a preset trigger event, a scenario displayed on the graphical user interface to be switched from the first virtual scenario to a second virtual scenario of a discussion stage; the second virtual scenario comprising an icon of the first virtual object and an icon of at least one further virtual object; the discussion stage comprising: a speaking stage and a voting stage, the speaking stage comprising a plurality of speaking periods, each virtual object speaking in a corresponding speaking period and entering the voting stage after the speaking stage ends; determining, in response to an attack operation initiated by the first virtual object in the discussion stage, a second virtual object corresponding to the attack operation; and determining a first to-be-eliminated virtual object from the first virtual object and the second virtual object based on the attack operation and a character attribute of the second virtual object.

In some embodiments, the processor implements the step of determining the first to-be-eliminated virtual object from the first virtual object and the second virtual object based on the attack operation and the character attribute of the second virtual object, which may include: determining, in response to the character attribute of the second virtual object being consistent with a target character attribute in the attack operation, the second virtual object as the first to-be-eliminated virtual object; and determining, in response to the character attribute of the second virtual object not being consistent with the target character attribute in the attack operation, the first virtual object as the first to-be-eliminated virtual object.

In some embodiments, after the processor implements the step of determining, in response to the discussion stage being in the speaking stage, the first to-be-eliminated virtual object from the first virtual object and the second virtual object, the process may include: controlling the first to-be-eliminated virtual object to be forbidden from speaking and/or voting.

In some embodiments, in response to the discussion stage being in the voting stage, after the processor implements the step of determining the first to-be-eliminated virtual object from the first virtual object and the second virtual object, the process may include: determining whether the first to-be-eliminated virtual object initiates a voting, in response to a detection operation of a voting operation on the first to-be-eliminated virtual object; determining a valid voting result based on voting information of the first to-be-eliminated virtual object and voting information of other virtual objects, in response to the first to-be-eliminated virtual object initiating a voting; counting the voting information of the first to-be-eliminated virtual object towards the valid voting result; not counting votes received by the first to-be-eliminated virtual object towards the valid voting result; determining a second to-be-eliminated virtual object based on the valid voting result; and displaying a voting result interface in the second virtual scenario, where the voting result interface displays voting information received by each of the virtual objects.

In some embodiments, after the processor implements the step of determining whether the first to-be-eliminated virtual object initiates a voting, in response to the detection operation of the voting operation on the first to-be-eliminated virtual object, the process may include: controlling the first to-be-eliminated virtual object to be forbidden from voting, in response to determining that the first to-be-eliminated virtual object does not initiate a voting.

In some embodiments, the processor implements the step of determining the second virtual object corresponding to the attack operation, in response to the attack operation sent from the first virtual object in the discussion stage, which may include: displaying an attack interface in response to a trigger operation of the first virtual object on an attack widget in the discussion stage; displaying a determination interface in response to a selection operation initiated for the second virtual object on the attack interface; and determining the second virtual object corresponding to the attack operation and the target character attribute, in response to a selection operation for the target character attribute among a plurality of character attributes on the determination interface.

In some embodiments, an icon of an uneliminated virtual object on the attack interface is displayed in a preset display mode; and the processor implements the step of displaying the determination interface in response to an attack operation initiated for the second virtual object on the attack interface, which may include: displaying the determination interface in response to a selection operation on the uneliminated virtual object on the attack interface.

In some embodiments, the processor may further implement a step of canceling the display of the attack interface in response to the trigger operation for the attack cancellation widget.

In some embodiments, the processor implements the step of determining the second virtual object corresponding to the attack operation, in response to the attack operation sent from the first virtual object in the discussion stage, which may include: determining whether the second virtual object corresponding to the attack operation is eliminated, in response to the attack operation initiated by the first virtual object in the discussion stage; determining, in response to the second virtual object not being eliminated, the second virtual object as the second virtual object corresponding to the attack operation; and determining, in response to the second virtual object being eliminated, that the attack operation is invalid.

In some embodiments, after the processor implements a step of determining that the second virtual object is the first to-be-eliminated virtual object, the process may include: displaying a preset victory animation on the icon of the first virtual object.

In some embodiments, after the processor implements a step of determining that the first virtual object is the first to-be-eliminated virtual object, the process may include: displaying a preset failure animation on a model of the first virtual object.

With the method for processing game data implemented by the process in the above embodiments, the player can initiate an attack operation in any stage in the discussion process, determine the second virtual object corresponding to the attack operation and a target character attribute exclusive for the second virtual object, and then determine the first to-be-eliminated virtual object from the first virtual object and the second virtual object based on the target character attribute and the character attribute of the second virtual object. With such an arrangement, the player can initiate an attack operation in the speaking stage based on his own judgment, or can listen to the speaking of all players, and, after all players complete speaking, initiate an attack operation in the voting stage, so that the player can flexibly initiate an attack operation in different stages based on his own needs, thereby avoiding the problem that previously, the player can initiate an attack operation merely in a preset stage and is restricted in operations. Moreover, after determining the first to-be-eliminated virtual object, the method provided in the present disclosure will also display a corresponding animation on the icon of the first to-be-eliminated virtual object to enrich the visual effect of the player, further improve the user experience of the player; and improve the fluency of initiating an attack operation when a game is running on the terminal device.

It should be understood that the apparatus and the method disclosed in the embodiments provided in the present disclosure may be implemented in other ways. For example, the apparatus embodiments described above are merely illustrative. For example, the division of the units is only a logical function division and there may be other manners of division during actual implementations. For example, a plurality of units or components may be combined or may be integrated into another system, or some features may be omitted or may not be performed. In addition, the illustrated or discussed coupling or direct coupling or communicative connection between each other may be indirect coupling or communicative connection among apparatuses or units via some interfaces, and may be electrical connection, mechanical connection, or other forms of connection.

The units described as separate components may or may not be physically separated, the components illustrated as units may or may not be physical units, and specifically, they may be located in a same place or may be distributed to a plurality of network units. A part or all of the units may be selected based on actual requirements to achieve the purpose of the solutions of this embodiment.

In addition, the functional units in various embodiments of the present disclosure may be integrated into one processing unit, or each unit may be physically present alone, or two or more than two units may be integrated into one unit. The above integrated unit may be implemented in the form of hardware, or may be implemented in the form of hardware with the addition of software functional units.

The integrated unit implemented in the form of the above-mentioned software functional unit may be stored in a computer-readable storage medium. The above-mentioned software functional unit is stored in a storage medium, and includes some instructions for causing a computer device (which may be a personal computer, a server, a network device, or the like) or a processor to implement some steps of the method according to the embodiments of the present disclosure. The above storage medium includes: various mediums that can store a program code, such as a U disk, a mobile hard disk, a Read-Only Memory (abbreviated as ROM), a Random Access Memory (abbreviated as RAM), a magnetic disk, or an optical disk.

1. A method for processing game data, comprising:
providing a graphical user interface via a terminal, the graphical user interface comprising a virtual scenario of a current round stage, the current round stage comprising an action stage and a discussion stage,
displaying, in the action stage, a first virtual scenario of the action stage on the graphical user interface, and controlling, in response to a moving operation for a first virtual object, the first virtual object to move in the first virtual scenario;
controlling, in response to a preset trigger event, the graphical user interface to switch from the first virtual scenario to a second virtual scenario of the discussion stage, the second virtual scenario comprising an icon of the first virtual object and an icon of at least one further virtual object, the discussion stage comprising a speaking stage and a voting stage, the speaking stage comprising a plurality of speaking periods, each virtual object speaking in a corresponding speaking period and entering the voting stage after the speaking stage ends;
determining, in response to an attack operation initiated by the first virtual object in the discussion stage, a second virtual object corresponding to the attack operation; and
determining a first to-be-eliminated virtual object from the first virtual object and the second virtual object based on the attack operation and a character attribute of the second virtual object.

2. The method according to claim 1, wherein determining the first to-be-eliminated virtual object from the first virtual object and the second virtual object based on the attack operation and the character attribute of the second virtual object comprises:
determining, in response to the character attribute of the second virtual object being consistent with a target character attribute in the attack operation, the second virtual object as the first to-be-eliminated virtual object; and
determining, in response to the character attribute of the second virtual object not being consistent with the target character attribute in the attack operation, the first virtual object as the first to-be-eliminated virtual object.

3. The method according to claim 1, wherein, in response to the discussion stage being in the speaking stage, after determining the first to-be-eliminated virtual object from the first virtual object and the second virtual object, the method further comprises:
controlling the first to-be-eliminated virtual object to be forbidden from speaking or voting.

4. The method according to claim 1, wherein, in response to the discussion stage being in the voting stage, after the determining the first to-be-eliminated virtual object from the first virtual object and the second virtual object, the method further comprises:
determining whether the first to-be-eliminated virtual object initiates a voting, in response to a detection of a voting operation on the first to-be-eliminated virtual object;
determining a valid voting result based on voting information of the first to-be-eliminated virtual object and voting information of other virtual objects, in response to the first to-be-eliminated virtual object initiating a voting;
counting the voting information of the first to-be-eliminated virtual object towards the valid voting result, and not counting votes received by the first to-be-eliminated virtual object towards the valid voting result;
determining a second to-be-eliminated virtual object based on the valid voting result; and
displaying a voting result interface in the second virtual scenario, wherein the voting result interface displays voting information received by each of the virtual objects.

5. The method according to claim 4, wherein, after determining whether the first to-be-eliminated virtual object initiates a voting, in response to the detection of the voting operation on the first to-be-eliminated virtual object, the method further comprises:
controlling the first to-be-eliminated virtual object to be forbidden from voting, in response to determining that the first to-be-eliminated virtual object does not initiate a voting.

6. The method according to claim 2, wherein the determining, in response to the attack operation initiated by the first virtual object in the discussion stage, the second virtual object corresponding to the attack operation comprises:
displaying an attack interface in response to a trigger operation of the first virtual object on an attack widget in the discussion stage;
displaying a determination interface in response to a selection operation initiated for the second virtual object on the attack interface; and
determining the second virtual object corresponding to the attack operation and a target character attribute, in response to a selection operation for the target character attribute among a plurality of character attributes on the determination interface.

7. The method according to claim 6, wherein an icon of an uneliminated virtual object on the attack interface is displayed in a preset display mode, and displaying the determination interface in response to an attack operation initiated for the second virtual object on the attack interface comprises:
displaying the determination interface in response to a selection operation on the uneliminated virtual object on the attack interface.

8. The method according to claim 6, wherein the method further comprises:
canceling display of the attack interface in response to a trigger operation for an attack cancellation widget.

9. The method according to claim 1, wherein the determining, in response to the attack operation initiated by the first virtual object in the discussion stage, the second virtual object corresponding to the attack operation comprises:
determining whether the second virtual object corresponding to the attack operation is eliminated, in response to the attack operation initiated by the first virtual object in the discussion stage;
determining, in response to the second virtual object not being eliminated, the second virtual object as the second virtual object corresponding to the attack operation; and
determining, in response to the second virtual object being eliminated, that the attack operation is invalid.

10. The method according to claim 1, wherein, after determining the second virtual object as the first to-be-eliminated virtual object, the method further comprises:
displaying a preset victory animation on the icon of the first virtual object.

11. The method according to claim 1, wherein, after determining the first virtual object as the first to-be-eliminated virtual object, the method further comprises:
displaying a preset failure animation on a model of the first virtual object.

12. (canceled)

13. One or more non-transitory computer-readable storage media containing, in any combination, computer program code that, when executable by a computer system, perform an operation comprising:
providing a graphical user interface via a terminal, the graphical user interface comprising a virtual scenario of a current round stage, the current round stage comprising an action stage and a discussion stage,
displaying, in the action stage, a first virtual scenario of the action stage on the graphical user interface, and controlling, in response to a moving operation for a first virtual object, the first virtual object to move in the first virtual scenario;
controlling, in response to a preset trigger event, the graphical user interface to switch from the first virtual scenario to a second virtual scenario of the discussion stage, the second virtual scenario comprising an icon of the first virtual object and an icon of at least one further virtual object, the discussion stage comprising a speaking stage and a voting stage, the speaking stage comprising a plurality of speaking periods, each virtual object speaking in a corresponding speaking period and entering the voting stage after the speaking stage ends;
determining, in response to an attack operation initiated by the first virtual object in the discussion stage, a second virtual object corresponding to the attack operation; and
determining a first to-be-eliminated virtual object from the first virtual object and the second virtual object based on the attack operation and a character attribute of the second virtual object.

14. A system, comprising:
one or more memories collectively containing one or more programs; and
one or more processors, wherein the one or more processors are configured to, individually or collectively, perform an operation comprising:
providing a graphical user interface via a terminal, the graphical user interface comprising a virtual scenario of a current round stage, the current round stage comprising an action stage and a discussion stage,
displaying, in the action stage, a first virtual scenario of the action stage on the graphical user interface, and controlling, in response to a moving operation for a first virtual object, the first virtual object to move in the first virtual scenario;
controlling, in response to a preset trigger event, the graphical user interface to switch from the first virtual scenario to a second virtual scenario of the discussion stage, the second virtual scenario comprising an icon of the first virtual object and an icon of at least one further virtual object, the discussion stage comprising a speaking stage and a voting stage, the speaking stage comprising a plurality of speaking periods, each virtual object speaking in a corresponding speaking period and entering the voting stage after the speaking stage ends;
determining, in response to an attack operation initiated by the first virtual object in the discussion stage, a second virtual object corresponding to the attack operation; and
determining a first to-be-eliminated virtual object from the first virtual object and the second virtual object based on the attack operation and a character attribute of the second virtual object.

15. One or more non-transitory computer-readable storage media according to claim 13, wherein determining the first to-be-eliminated virtual object from the first virtual object and the second virtual object based on the attack operation and the character attribute of the second virtual object comprises:
determining, in response to the character attribute of the second virtual object being consistent with a target character attribute in the attack operation, the second virtual object as the first to-be-eliminated virtual object; and
determining, in response to the character attribute of the second virtual object not being consistent with the target character attribute in the attack operation, the first virtual object as the first to-be-eliminated virtual object.

16. One or more non-transitory computer-readable storage media according to claim 13, wherein, in response to the discussion stage being in the speaking stage, after determining the first to-be-eliminated virtual object from the first virtual object and the second virtual object, the operation further comprises:
controlling the first to-be-eliminated virtual object to be forbidden from speaking or voting.

17. One or more non-transitory computer-readable storage media according to claim 13, wherein, in response to the discussion stage being in the voting stage, after the determining the first to-be-eliminated virtual object from the first virtual object and the second virtual object, the operation further comprises:
determining whether the first to-be-eliminated virtual object initiates a voting, in response to a detection of a voting operation on the first to-be-eliminated virtual object;
determining a valid voting result based on voting information of the first to-be-eliminated virtual object and voting information of other virtual objects, in response to the first to-be-eliminated virtual object initiating a voting;
counting the voting information of the first to-be-eliminated virtual object towards the valid voting result, and not counting votes received by the first to-be-eliminated virtual object towards the valid voting result;
determining a second to-be-eliminated virtual object based on the valid voting result; and
displaying a voting result interface in the second virtual scenario, wherein the voting result interface displays voting information received by each of the virtual objects.

18. One or more non-transitory computer-readable storage media according to claim 17, wherein, after determining whether the first to-be-eliminated virtual object initiates a voting, in response to the detection of the voting operation on the first to-be-eliminated virtual object, the operation further comprises:
controlling the first to-be-eliminated virtual object to be forbidden from voting, in response to determining that the first to-be-eliminated virtual object does not initiate a voting.

19. One or more non-transitory computer-readable storage media according to claim 15, wherein determining, in response to the attack operation initiated by the first virtual object in the discussion stage, the second virtual object corresponding to the attack operation comprises:
displaying an attack interface in response to a trigger operation of the first virtual object on an attack widget in the discussion stage;
displaying a determination interface in response to a selection operation initiated for the second virtual object on the attack interface; and
determining the second virtual object corresponding to the attack operation and a target character attribute, in response to a selection operation for the target character attribute among a plurality of character attributes on the determination interface.

20. One or more non-transitory computer-readable storage media according to claim 19, wherein an icon of an uneliminated virtual object on the attack interface is displayed in a preset display mode, and displaying the determination interface in response to an attack operation initiated for the second virtual object on the attack interface comprises:
displaying the determination interface in response to a selection operation on the uneliminated virtual object on the attack interface.

21. One or more non-transitory computer-readable storage media according to claim 13, wherein determining, in response to the attack operation initiated by the first virtual object in the discussion stage, the second virtual object corresponding to the attack operation comprises:
determining whether the second virtual object corresponding to the attack operation is eliminated, in response to the attack operation initiated by the first virtual object in the discussion stage;
determining, in response to the second virtual object not being eliminated, the second virtual object as the second virtual object corresponding to the attack operation; and
determining, in response to the second virtual object being eliminated, that the attack operation is invalid.
